(19) United States
(12) Patent Application Publication
(10) Pub. No.: US 2006/0174262 A1
(43) Pub. Date: Aug. 3, 2006

(54) Method for transmitting a user-specific program

(75) Inventors: Eric Thelen, Aachen (DE); Andreas Kellner, Aachen (DE); Jan Kneissler, Aachen (DE); Holger R Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N. V., Eindhoven (NL)

(21) Appl. No.: 10/549,348

(22) PCT Filed: Mar. 11, 2004
(86) PCT No.: PCT/IB04/50236

§ 371 Date: Sep. 14, 2005

(30) Foreign Application Priority Data
Mar. 19, 2003 (EP) 03100704.0

(51) Int. Cl. H04N 7/16

(52) U.S. Cl. 725/25

(57) ABSTRACT

A method for transmitting a user-specific program to the user of a program content transmission system (1) is described, in which first a part of the program contents (P) of the program is transmitted to a first terminal unit (A) of the user and the program transmission to the fist terminal unit (A) is stopped when a first defined event occurs in accordance with a pre-determined procedural sequence. Subsequently, when a second defined event occurs, for the continuation of the program transmission, there is then a further transmission of program contents (P′) of the program to a second terminal unit (B) of the user in accordance with a pre-determined procedural sequence. Moreover, a respective program content transmission system (1) and an terminal unit (A, B) for use in this type of transmission method are described.

The invention relates to a method for transmitting a user-specific program to a user of a program content transmission system.

A program content transmission system refers to each system that sends preferably digital audio and/or visual contents such as films, shows, news, radio plays, music or multimedia content to its users, i.e. to its listeners and viewers respectively. The program content can then be transmitted in any desired way, wireless, for example via terrestrial and/or satellite-supported radio networks and/or wire-bound, for example, via broadband cables. The program content, which is normally stored on a server of the program content transmission system or generated “live”, can be received accordingly by the users with the most varied devices and used in a most diverse way depending on the type of the program content. It is only necessary for the devices to be compatible with the respective transmission specifications of the program content transmission system and have the possibility of outputting the transmitted program content to the user, i.e. for example of making them visible and/or audible. An example of this is a conventional broadcasting system such as a television and/or sound broadcasting system, whose transmitted television and sound broadcasting programs can usually be received by the user with all sorts of devices such as e.g. a car radio, a television set or a PC with corresponding reception function.

For some years experts have already been endeavoring to set up “personalized broadcasting systems” (personal radio, personal TV) along with conventional broadcasting systems, in which personalized broadcasting systems the users can receive not only the programs broadcast for all users together, but also those user-specific programs composed individually for the individual users and/or for user-groups, which are tailored to the needs of the particular users as well as user groups. This is made possible by the constantly improved technical transmission possibilities and bigger bandwidths in order that the number of the available transmission channels represent no or only a minor limiting magnitude. The user-specific programs may also be virtual programs, which, from a technical point of view, comprise an individual order of program content which is also jointly available on the various channels. The preparation of a user-specific program normally takes place on the basis of direct instructions from the user and/or on the basis of user-profiles, which are produced on account of the user attitude or through statements from the user. Accordingly, with the preparation of a specific program for a user-group, selection of the program contents is possible on the basis of user group profiles. An initially already practiced system for transmitting individual personalized programs is what is called Internet Radio. Another variation of program content transmission systems for transmitting user-specific programs to individual users, are systems in which the user composes programs from content stored in the system by himself, for example own videos, pieces of music etc. and can store the completed programs on a server of the system again and can later recall these as required from the various end devices. Furthermore, mixed systems are also possible, in which for example a user's own program content stored by himself in a personalized broadcasting system is integrated with the individual program otherwise produced by a professional content provider.

Normally, a user would like to be able to receive his individual, user-specific program like in a conventional broadcasting system from several different appliances, depending on the place he is at and which receiver is available to him there. A typical example for this is a user who hears his personal radio program on his own stereo system over breakfast in the morning. Subsequently, he would like to carry on hearing the program on his car radio on the way to work. A problem is then that after switching off the stationary stereo system at home and until switching on the car radio usually a certain time elapses in which the user misses out on part of the transmitted program content. This is normally unsatisfactory to the user in case of the reception of conventional, non-personalized radio programs. With the reception of personal programs, it is to be assumed that missing out on program content is even more annoying to the user.

It is therefore an object of the present invention to provide a method for transmitting a user-specific program, in which the user of the program content transmission system can change in comfortable manner from one terminal unit to another.

This object is achieved by a method of the type defined in the opening paragraph in which first a part of the program content of the program is transmitted to a first terminal unit of the user and the program transmission to the first terminal unit is stopped in accordance with a pre-determined procedural sequence when a first defined event occurs and then, when a second defined event occurs, the program content is further transmitted to a second terminal unit of the user to continue the program transmission in accordance with a predetermined procedural sequence.

The program or the program content respectively is just not broadcast any further on a transmission channel to the user after the first end device has been switched off, so that until the second end device is switched on, the user misses out on the program content meanwhile broadcast on the particular channel. Instead, the program broadcast is stopped in a way that is suitable for the respective situation and for the program content transmitted at the time. Subsequently—after the user is ready for the further reception of the program on a second terminal unit—the program transmission is resumed in a way that is adjusted to the then occurring utilization situation or current program content.

For this purpose, the program content transmission system according to the invention requires a program management device to render user-specific programs assigned to the respective users available to the various users of the program content transmission system. Furthermore, a number of transmission channels must be available for transmitting the program contents of the user-specific programs on the terminal units of the users involved. Finally, the program content transmission system requires a device management facility to stop the program transmission to the user's first terminal unit in accordance with the pre-determined procedural sequence when a first defined event occurs and to prompt continuation of the program transmission on the user's second terminal unit in accordance with the pre-determined procedural sequence when a second defined event occurs.

The dependent claims include each particularly advantageous embodiments and further aspects of the invention.

The first and the second defined events may be different actions.

For example, the first defined event may relate to the start of a certain point of time, for example on weekdays always 7:30 in the morning. Similarly, the second point of time may be a fixedly defined point of time. The second event may particularly also be the end of a certain time span after the stop of the transmission on the first terminal unit or after the first event respectively. With these variants, the first device would switch off automatically at a specific time and the second device would resume transmission at another defined time. This is meaningful only if the user usually has a precisely pre-determined, fixed routine at these times. The user can then at the same time use the default times, which are signaled to him by the program termination or the program resumption, as an alarm function.

Further possible events are program-internal events such as the end of a certain program or an interruption forced by the program content transmission system itself, for example because the transmission channel is blocked or interfered.

In an embodiment, which offers particularly large variability to the user, the first defined event exists in the reception of a transmission stop signal from a terminal unit of the user. The terminal unit that sends the transmission stop signal is usually the receiving first terminal unit. In this case according to the definition the term “signal” refers to any sign given through optical, acoustic, electrical or other technical means for the transmission of messages, information and especially commands.

The transmission stop signal itself may in principle be a relatively simple signal, which is transmitted to the program content transmission system for example when the first terminal unit is switched off. It is clear that in this case the program content transmission system is to have corresponding return channels, via which the terminal unit can transmit the transmission stop signal to the program content transmission system. Similarly, the terminal unit must have a corresponding transmit facility in this case to transmit the transmission stop signal to the program content transmission system.

The second defined event is preferably the reception of a transmission continuation signal, which can be sent out similarly from a terminal unit of the user. This is normally the new receiving terminal unit itself. In this case, the terminal unit must have a corresponding transmit facility for transmitting a transmission continuation signal. For example, a transmission continuation signal can be automatically transmitted via a corresponding return channel to the program content transmission system when the terminal unit is switched on. It is also possible, however, for the user for example to send this transmission continuation signal at a certain time by pressing a specific button. In this case, he can switch on for example, first the new terminal unit and receive a “normal” general program and at a later point of time decide to receive the individual own program. The transmission continuation signal preferably includes information about the terminal unit used for the further reception and about the user-specific program and the associated user involved.

Both the transmission stop signal and the transmission continuation signal can also be transmitted from another one than the receiving terminal unit, for example from a fixed network telephone or a mobile radio device of the user, in which case respective information about the receiving terminal unit, at the point of time involved and/or the user-specific program and/or the user and the new receiving device is to be transmitted along.

Preferably, the transmission continuation signal also includes information about the new situation of use, for example whether it is a reception during a drive or a reception in the office etc.

There are various variants available for the precise procedural sequence when the program transmission is stopped or continued. The method for the program content transmission system may then basically be fixed. Preferably, the procedural sequence varies in dependence on the respective situation of use, on the program content broadcast at the relevant time and/or at the user's direct request.

In a preferred variant simply a time stamp is put in the running program when the first event occurs and at the time of the actual transmission stop. When the second event occurs, the transmission of the further program content then starts exactly at this time stamp. In that case the program transmission stops in the middle of the program and the continuation begins exactly at the same point. In a particularly preferred embodiment, the transmission of the further program contents, however, is continued at a pre-determined interval before the set time stamp. This means that the last part of the program content broadcast before the program transmission is stopped, is repeated in order for the user to be easily back to the program again.

In another variant is provided that when the first event occurs first the transmission of the running program content section is terminated before the transmission stop. This can be made dependent on the length of the period until the particular program content section normally comes to an end. In this way for example the user can define a specific point of time when the transmission to the first end device should be stopped and then is checked about this point of time, whether the running program would run longer than a specific acceptable time span. If this is not the case, fist the end of the respective program content section is waited for and then the transmission is stopped.

In addition, it is possible for a respective message to be announced and/or displayed on a display at the end of the program transmission. “The program transmission was properly interrupted. You may continue the program on another appliance at any time.”

In another variant is provided that the running program content section is ended before the transmission stop in an abridged form, for example in the form of a synopsis. Similarly, it is possible—particularly with a transmission of music contents—to fade out the program.

Much as such “soft” interruptions of the transmission are possible, there are also procedural sequences for continuing the transmission on the second terminal unit.

Apart from the variant already described, in which first a part of the program-content is repeated for the continuation of the program, there is the possibility that first there is a continuation prelude at the beginning of the continuation of the program in the form of a summary of at least a part of the program content transmitted before the transmission stop. Alternatively or additionally, a special announcement or something similar can be made, which also contains information about the interruption of the program such as, for example: “We are continuing your personal program, which you have stopped at 8:00 o'clock this morning.”

In a particularly preferred embodiment the user-specific program is adapted before the continuation of the transmission by the program content transmission system, for example, by the content supplier to the second terminal unit used and/or the new conditions of use.

An adaptation of the program to the new terminal unit used may imply for example an adaptation of the video data resolution, if the new appliance uses a different display than the appliance used before. Similarly, it is possible to adapt the audio data transmission. For example, corresponding super audio data are transmitted when a Hi-fi appliance is used, only mono audio data are transmitted when a simple mono appliance is used and MP3 data are transmitted when an MP3 appliance is used.

The adaptation of the program or program content, respectively, has the advantage that the available appliance features are optimally used for a maximum audio and visual experience, on the other hand, however, the transmission bandwidth is also used optimally and data, which cannot be used by the respective device, are not transmitted unnecessarily.

Such an adaptation to the appliance can also comprise the change of the user-specific program in sofar that for example planned program contents, which are not suitable for the new appliance, are no longer sent to the respective appliance, but are instead exchanged by other suitable program-contents. For example particular music program content, which can be output in sensible manner to the user only by using a terminal unit with a relatively good audio output facility, is no longer sent if only a primitive mono device is available.

In similar manner, an alteration of the program contents of the user-specific program and addition of new program contents or an omission of already provided program contents is meaningful for adapting the program to the new user situation. For example, additional traffic announcements can be added to the user-specific program, if the program is continued by the car radio and it may be assumed that the user needs these traffic announcements at the relevant time. For this purpose it is appropriate for the information utilization scenario to be informed to the program content transmission system for example via the transmission continuation signal. When a car radio is used, this may also include a transmission of the current position and the destination.

Just as much, an adaptation of the program to other conditions of use, for example to differently used transmission channels is possible. The sensitivity to interference of the respective transmission channel can then be taken into account. For example, interference is to be anticipated more frequently with reception in a car than with reception on a home stereo via broadband cable.

A reorganization of the user-specific program before the continuation of the transmission is also meaningful if for example the time planning changes, especially in the cases where the program is interrupted at an unexpected time—for example earlier than usual. As a rule, the predefined periods of time for the preparation of a user-specific program are closely linked with the respective utilization scenario. A typical example of this is a radio program, which is designed for exactly one hour based on the statements of the user, which program the user hears every morning. The user listens to this program at breakfast for half an hour and for another half hour in the car during the trip to work. If the user by way of exception finishes his breakfast early and breaks off the program transmission to the first terminal unit after 20 minutes, the program content transmission system and/or the content supplier are still left with a total of 40 minutes of program, which should be transmitted to the user. Since, on the other hand, it is to be assumed that the subsequent drive also lasts only 30 minutes, as usual, consequently the remaining program with a length of 40 minutes has to be reorganized in a way that it can be broadcast within the 30 minutes. This can be done for example by leaving out or shortening certain program contents in the form of summaries. Conversely, an extension of the program is also possible, if the user switches off later than usual by way of exception. Additional program contents may then be included in this case.

Preferably, such a reorganization or adaptation of the user-specific program to the terminal unit as well as to the new utilization conditions takes place on the basis of the user profile and/or profile of the appliance. As a rule, these profiles are already stored by the program content transmission system and at the content supplier's anyway. However, they can also be transmitted to the system for example together with the transmission stop signal and the transmission continuation signal and updated. Then for example exactly the program-contents that have the lowest priority for the user based on the user-profile, are left out or program contents with the next-higher priority are included.

These and other aspects of the invention are apparent from and will be elucidated with reference to the attached drawings with the help of the useful embodiments described hereinafter. In the drawings:

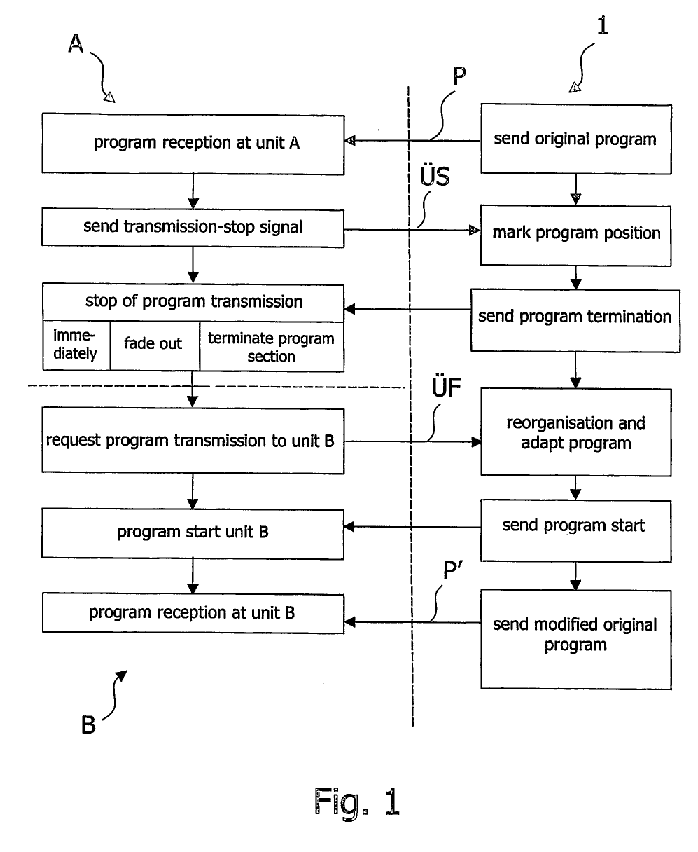

FIG. 1 shows a flow chart for the handover of program reception from a first terminal unit to a second terminal unit,

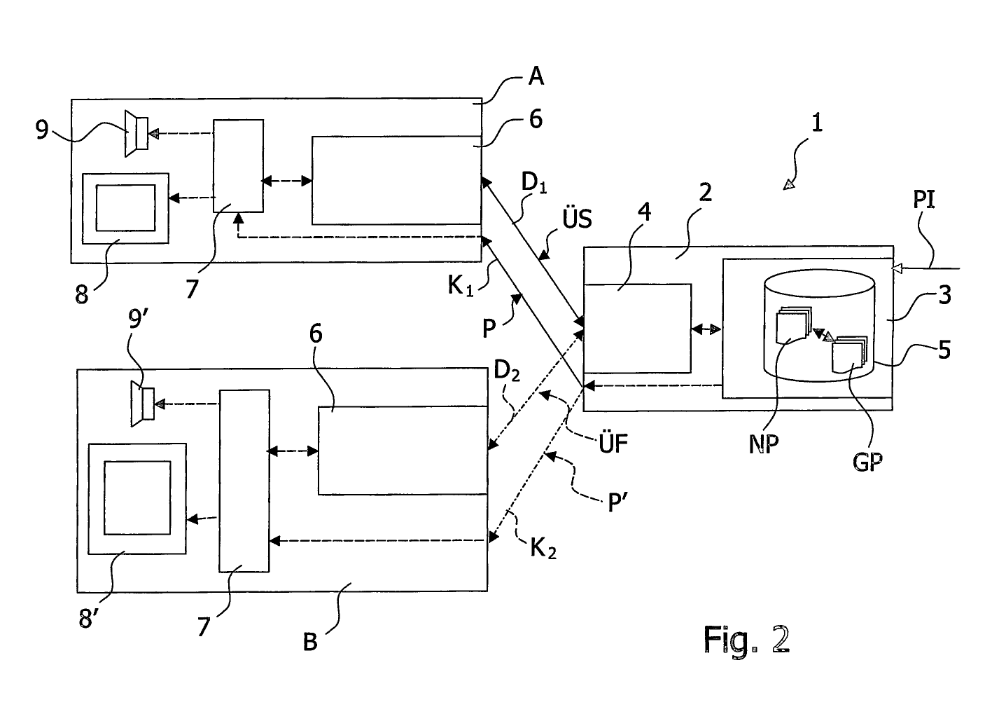

FIG. 2 shows a simplified basic diagram of the system architecture of a program content transmission system and two terminal units according to the invention.

In the following description of the embodiments shown in the figures it is assumed for the sake of simplicity that the program content transmission system concerns a broadcasting system—i.e. a radio or television system—which is suitable for broadcasting individual user-specific programs. The invention however is not restricted to such program content transmission systems.

FIG. 1 shows in a flow chart how the individual units A, B and the program content transmission system 1 react at the time of the handover of the program transmission from a first terminal unit A to another terminal unit B and the interaction between the system and the units A, B. The functions of the program content transmission systems 1 are displayed on the right-hand side of the vertical dotted line and the functions of the respective terminal units A, B are on the left-hand side of the vertical dotted line. The left-hand side is in turn interrupted by a dotted horizontal line, in which the actions of the first receiving terminal unit A are displayed above this line and below the dotted line the actions of the second terminal unit B taking over reception.

As is clearly seen from FIG. 1, first the program content P of the original program is transmitted to the unit A by the radio system 1. Subsequently the terminal unit A sends a transmission stop signal ÜS to the radio system 1, which then marks the current program position within the original program. A program transmission is stopped at the end terminal unit A, upon which the radio system 1 sends a program termination to the terminal unit A, with a message that the program is properly interrupted. Alternatively, the program transmission can be stopped immediately i.e. abruptly or with a current transmission of music for example through fading. Moreover, prior to the interruption, first the currently sent program section can be terminated while the program termination sent by the radio system 1 may also include a summary of the remaining program section, which is sent instead of the complete remaining program section.

Subsequently, transmission continuation signal ÜF is broadcast at any further point of time by the device B to the radio-system 1, to thus request the program transmission to the device B. Then the radio system 1 or content provider reorganizes and adapts the program to the unit B to the new user situation and particularly to the new time conditions. Subsequently, a program start is sent by the radio system 1 to the unit B, which for example, once again contains a summary of program content section or another announcement broadcast before the program interruption. Finally, the altered original program P′ is broadcast to the unit B.

FIG. 2 shows the components required for this purpose in the terminal units A, B and the radio system 1 to execute this method. The two terminal units A, B are basically similar units, but different in detail. Both terminal units A, B have a central control and output facility 7, which outputs the program contents P, P′ received via transmission channels K1, K2 of the radio system 1 in suitable manner to the output device, here for example a display 8.8′ and a TV screen and loudspeaker system 9.9′. However, the two terminal units A, B may have different displays 8.8′, for example with different resolution and different loudspeaker systems 9.9′.

According to the invention, both units A, B also have a communication module 6, which is connected to the central control and output device 7 of the unit A, B and which is used for sending signals and data to the radio system 1 via data channel D1, D2, as well as for receiving respective signals and data from the radio system 1 for controlling the terminal units A, B as defined by the method according to the invention for example, the transmission stop signal or the transmission continuation signal as well as program links.

The radio system 1 shows a unit management system 4, which receives the signals as “unit communication module” from the communication module 6 of the terminal units A, B and sends out corresponding signals and program links to the communication module 6 of the terminal units A, B. This may be a software module implemented on a server 2.

Another essential component of the displayed radio system 1 is a program management system 3, preferably also in the form of a software module implemented on a server 2. This program management system 3 is used for providing user-specific programs P for the various users of the radio system 1. For this purpose the system contains program contents P1 from most diverse sources (not shown), which are composed in accordance with various user profiles NP and unit profiles GP, which are stored in a database 5. The user profiles NP and the unit profiles GP are in this case interconnected insofar as certain units can be assigned to certain users and vice versa. The unit management system 4 and the program management system 3 interact in this respect in that via the unit management system 4 is predefined to the program management system 3 via which transmission channel K1, K2 and to which unit A, B of a specific user a user-specific program assigned to this user or its program content is broadcast, respectively.

After the unit management system 4 has been predefined to the unit A, B, the program management system 3 adapts the user-specific individual program to the unit A, B and to conditions of use in the given embodiment. The information about the conditions of use can then be transmitted via the communication module 6 of the terminal units A, B to the unit management system 4 which then forwards the data in suitable form to the program management system 3.

FIG. 2 shows of both terminal units A, B and the radio system 1 only the most essential components for clarity. It is clear that these units and the radio system also have all other components, which are normally included in this type of terminal units and radio system such as, for example, suitable user interfaces, corresponding reception facilities for the selection of the received transmission channels K1, K2 etc.

Finally, it is once again pointed out that the program content transmission systems and method shown in the figures and the description involves only embodiments, which can be varied by the expert on a large scale, without leaving the scope of the invention. Thus the architectures of the various units and the program content transmission systems can be modified in many details. For example, unit management system 4 and program management system 3 can also be arranged as a common system that complies with the respective functions in a different manner than the embodiment shown. On the other hand, the functions of these systems can also be distributed over several interconnected servers etc. Furthermore, further procedure steps can be incorporated with the procedural sequence described in detail. In addition, for completeness' sake it is pointed out that the use of indefinite article “a” or “an” does not rule out that the particular features can also exist in multiples and that the use of the term “comprise” does not exclude the existence of further elements or steps.

1. A method for transmitting a user-specific program to a user of a program content transmission system (1), in which first a part of the program content (P) of the program is transmitted to a first terminal unit (A) of the user and the program transmission to the first terminal unit (A) is stopped in accordance with a pre-determined procedural sequence when a first defined event occurs and then, when a second defined event occurs, the program content (P′) is further transmitted to a second terminal unit (B) of the user to continue the program transmission in accordance with a predetermined procedural sequence.

2. A method as claimed in claim 1, characterized in that the first defined event comprises the reception of a transmission stop signal (ÜS) and/or the second defined event comprises the reception of a transmission continuation signal (ÜF) from an end device (A, B) of the user.

3. A method as claimed in claim 2, characterized in that a time stamp is put in the program when the first event occurs or when the transmission is stopped and the transmission of the further program content (P′) begins when the second event occurs at this time stamp or at a pre-determined distance before this time stamp.

4. A method as claimed in claim 1, characterized in that when the first event occurs first the transmission of a running program content section is terminated before a transmission stops.

5. A method as claimed in claim 4, characterized in that the running program content section is terminated in abridged form before the transmission stop.

6. A method as claimed in claim 1, characterized in that at the continuation of the program first there is a continuation prelude and/or a summary of at least a part of the program contents (P) transmitted before the transmission stop.

7. A method as claimed in claim 1, characterized in that the user-specific program and/or the program contents are adapted before the continuation of the transmission to the second terminal unit (B) and/or to the new conditions of use.

8. A method as claimed in claim 1, characterized in that the user-specific program (P) is reorganized before the transmission is continued.

9. A method as claimed in claim 7, characterized in that the adaptation and/or reorganization of the user specific program takes place on the basis of a user-specific (NP) and/or device profile (GP).

10. A program content transmission system (1) comprising:
a program management system (3) to render user-specific programs assigned
to the respective users available to the various users of the program content transmission system (1),
a number of transmission channels, K₁, K₂ for the transmission of program
contents (P,P′) of the user-specific programs to the terminal units, (A, B) of the particular users,
a unit management system (4) to stop the program transmission to a first terminal unit (A) of a user in accordance with a pre-determined procedural sequence when a first defined event occurs and, when a second defined event to continue the program transmission in accordance with a pre-determined procedural sequence occurs, to cause a continuation to take place of a transmission of program contents (P′) to a second terminal unit (B) of the user.

11. A terminal unit (A, B) for use in a method as claimed in claim 1, comprising a receiving facility (7) for the reception of program contents (P, P′), of a user-specific program assigned to the user of the terminal unit (A, B) of a program content transmission system (1) and comprising a module (6) for communicating a transmission stop signal (ÜS) and/or a transmission continuation signal (ÜF) to the program content transmission system
